(19) United States
(12) Patent Application Publication
(10) Pub. No.: US 2019/0232443 A1
(43) Pub. Date: Aug. 1, 2019

(54) RAIL OF A MACHINE APPARATUS WITH A TRAVELING CARRIAGE

(71) Applicant: Koike Sanso Kogyo Co., Ltd., Tokyo (JP)

(72) Inventors: Tomoaki KITAJIMA, Tokyo (JP); Kazumasa HOSOYA, Tokyo (JP)

(73) Assignee: Koike Sanso Kogyo Co., Ltd., Tokyo (JP)

(21) Appl. No.: 15/883,405

(22) Filed: Jan. 30, 2018

(51) Int. Cl. B23Q 1/40; B61C 11/04; B23Q 3/00; B61C 11/00

(52) U.S. Cl. CPC B23Q 1/40; B61C 11/005; B23Q 3/005; B61C 11/04

(57) ABSTRACT

Disclosed is a rail of a machining apparatus having a traveling carriage, wherein rail members of a rail are connected at a rail member connecting portion in series such that running surfaces of adjacent rail members are in contact with each other, wherein the rack members are arranged in series on an attachment surface of the rail member such that an interval between teeth of adjacent rack members at a rack member opposing portion at which the adjacent rack members are opposed to each other is the same as a predetermined tooth pitch of the rack members, and wherein the rack members are attached to an attachment surface of the rail member by bolts which are inserted through the elongated holes formed on the attachment surface and which are screwed into the threaded holes of the rack member.

### BACKGROUND OF THE INVENTION

### Field of the Invention

The present invention relates to a rail of a machine apparatus having a traveling carriage for performing a desired work on a workpiece by operating a machining unit mounted on the traveling carriage.

### Description of the Related Art

As a machine apparatus for carrying out preset machining on a workpiece while traveling along a rail, there are a cutting apparatus for cutting a workpiece, a welding apparatus for welding a workpiece, a printing apparatus for drawing a character or a line on a surface of a workpiece, a heating apparatus for heating a surface of a workpiece, a painting apparatus for painting a surface of a workpiece, a peeling apparatus for peeling the painting on a surface of a workpiece, a conveying apparatus for conveying a workpiece while sucking it and so on.

For example, when manufacturing a member of a structure such as a ship, a bridge, a building, there are cases where machining such as marking, printing, painting, peeling of painting is performed on a surface of workpieces including a steel plate or a stainless steel plate. In these cases, it is general to use a machine apparatus having a traveling carriage on which a machining unit having a function selected from a marking unit, a printing unit, a painting unit, a peeling unit or the like corresponding to the material of a workpiece or a work content is mounted.

In manufacturing the above-mentioned member, it is also performed to suck or hang a workpiece or a manufactured member and to convey it to a desired position. In this case, it is general to use a machine apparatus having a traveling carriage on which a machining unit is mounted, which has a conveying function, selected from a suction unit, a hanging unit and the like corresponding to conditions such as a material, a size and a weight of a workpiece or a product to be conveyed.

In the above-described machine apparatus, it is often required to have a high accuracy in the initial position of the mounted machining unit for a workpiece and the positional accuracy when moving the machining unit during machining.

For example, it is general to produce a member of the structure such as a ship, bridges, buildings, and the like by using a machine apparatus having a traveling carriage on which a cutting torch as a machining unit selected from a gas cutting torch, a plasma cutting torch, a laser cutting torch or the like is mounted, and by machining (cutting) a steel plate or a stainless steel plate or the like as a workpiece. Such a member is often joined to another member by means such as welding, and high dimensional accuracy is required.

Next, the configuration of the cutting apparatus will be described as an example of a machine apparatus having a traveling carriage. The cutting apparatus includes a traveling carriage which has a saddle arranged corresponding to a pair of rails arranged in parallel and a garter arranged in a direction orthogonal to the rails and fixed to the saddle. In particular, when the width dimension of a workpiece to be cut is large, respective rails are installed on both sides in the width direction of the workpiece, and the garter of the traveling carriage is arranged in a direction traversing the rails and the traveling carriage is formed in a gate shape.

A traversing carriage traversing in a direction orthogonal to the rail installation direction is arranged on the garter of the traveling carriage, and a cutting torch as a machining unit is mounted on the traversing carriage. Then, by controlling the running direction and the traveling speed of the traveling carriage and the traverse direction and the traverse speed of the traversing carriage synchronously, the cutting torch is moved in the direction and the speed corresponding to the shape to be cut. Therefore, in accordance with the movement of the cutting torch, it is possible to cut a product having a target shape from the workpiece.

In particular, when making a product with strict dimensional accuracy from the workpiece by cutting, the straight traveling accuracy and the dimensional accuracy in the traveling direction of the traveling carriage and the straight traveling accuracy in the traverse direction and the dimensional accuracy of the traversing carriage are respectively highly required.

A head portion of the rail is subjected to precise machining in order to secure straight running accuracy of the traveling carriage in the traveling direction along the rail. On the top surface of the rail, the traveling surface on which the traveling roller travels is formed. On both sides of the running surface, guide surfaces are formed, with which the guide rollers are in contact and on which it rotates. The running surface and the guide surfaces are formed as a flat surface so that the running roller and the guide roller can smoothly rotate.

An attachment seat for attaching the rack is formed on the web portion which connects the head portion and the bottom portion. Attachment holes of round holes with a predetermined pitch are formed on the attachment seat. A plurality of traveling rollers to be placed on the traveling surface of the rail, a plurality of guide rollers for pinching the guide surfaces, and a pinion meshed with the rack are disposed in the traveling carriage.

The plurality of rail members constituting the rail have a predetermined length. In addition, since the length of the rail to be installed is set according to various conditions such as the length of the workpiece and the work procedure, the installation length may reach several tens of meters to a hundred and several tens of meters. Therefore, several to several tens of rail members are arranged in series to the installation place of the cutting apparatus and the rail members are installed maintaining strict straightness (for example, several to several tens of rail members having a length of 3 (m) may be installed in each row).

When installing the rails, each rail member is supported by a plurality of adjustment blocks fixed in advance at a target installation place, and the level and straightness are adjusted by the adjustment blocks and fixed. Therefore, the accuracy of horizontal traveling of the traveling carriage placed on the rails is ensured by the traveling roller being placed on the running surface and the accuracy of straight running is ensured by the guide rollers pinching the guide surfaces.

In particular, when a gap is formed between the adjacent rail members connected in series, an impact is generated when the traveling carriage gets over this gap to adversely affect the cut surface. Therefore, the rail members are installed so that the end faces are in close contact with each other.

Furthermore, in order to cope with the dimensional accuracy required in addition to the straight advancement accuracy in the traveling direction of the traveling carriage, the rack is arranged on the attachment seat formed on the web portion of the rail, and the rack is attached via the bolts inserted through the attachment holes. A drive mechanism including a pinion meshing with the rack and a traveling motor for driving the pinion, and a control mechanism for controlling the rotation of the traveling motor are arranged on the traveling carriage. Then, by using the numerical control device (NC device) as the control mechanism and by controlling the rotation direction and the rotation speed of the pinion, the traveling direction along the rail and the running speed of the traveling carriage is controlled. Therefore, the traveling direction and the accuracy of the traveling distance of the traveling carriage are ensured.

In particular, when the traveling carriage is large, this traveling carriage has a pair of saddles corresponding to each pair of rails installed in parallel, and a pinion and a traveling motor are arranged on each of these saddles. Then, each of the traveling motors is driven on the basis of a running command from the NC device, and the pinion rotates and the traveling carriage travels in a predetermined direction at a predetermined speed. At this time, the moving distances of the pair of saddles must be exactly the same. That is, when the pair of moving distances are different, the angle of the garter of the traveling carriage with respect to the rail varies and the machining accuracy cannot be maintained. Therefore, it is essential to ensure the attachment accuracy of the rack.

From the viewpoints of processing conditions, processing accuracy and the like, it is difficult to manufacture a long rack member. The rack member is short as compared with the length of the rail member. The rack member is normally about ¼ of the rail member. Therefore, when attaching the rack member to the rail member, there are many connecting portions. Especially, when the rack member is attached to the rail member in series, fluctuation in the gap of the connection portion becomes fluctuation of the tooth pitch, which affects the dimensional accuracy, so it becomes necessary to strictly manage this gap.

Processing tolerances are set for each rack member and each rail member, respectively. Therefore, when these rack members and these rail members are arranged in series, respectively, mutually independent cumulative errors affect each other. In order to alleviate this effect, attaching rack members to individual rail members is performed in advance. However, in installing the rail, when the adjacent rail members are brought into close contact with each other, there is no guarantee that the gap between the adjacent rack members will match exactly with the pitch of the teeth.

In particular, when the rail members are connected, by arranging a rack member at the connecting portion, it is possible to integrate the rail members. For this reason, upon shipment from a factory, the rack member protrudes from an end portion of a rail member, which adversely affects the loadability. From this point of view, in the case of installing the rail at the intended installation place, the attachment holes which are round holes are formed at the predetermined pitch on the web portion of the rail member in advance. The connecting surface of the rack member is made as a flat surface without a threaded hole.

Then, the rail member and the rack member are carried to the target installation place. After that, the rail of the desired length is installed by ensuring the horizontal accuracy and the straight advance accuracy firstly. Thereafter, with one end of the installed rail being as a reference, the rail member is connected in series while adjusting the gap of the connecting portion between the rack members to be equal to the tooth pitch and the positions of the threaded holes are marked on the rack member with reference to the attachment holes formed on the rail member. At the installation site, threaded holes are formed at the marked positions and the rack members are fastened to the rail members by bolts to constitute the rack.

In the case where the machine apparatus is a welding apparatus, the welding apparatus comprises a traveling carriage on which a welding torch is mounted as a machining unit selected from a carbon dioxide gas welding torch, a plasma welding torch, a laser welding torch and the like corresponding to the material of the workpiece. In the case where the machine apparatus is a printing apparatus, this printing apparatus comprises a traveling carriage on which a printing unit as a machining unit suitable for printing characters and lines on a workpiece is mounted.

In the case where the machine apparatus is a heating apparatus, the heating apparatus comprises a traveling carriage on which a heating torch as a machining unit selected from a gas heating torch, a plasma heating torch, a laser heating torch or the like is mounted. In the case where the machine apparatus is a peeling apparatus, the peeling apparatus comprises a traveling carriage on which a peeling unit as a machining unit selected from a rotating brush, a sandblasting nozzle or the like is mounted. In the case of a painting apparatus, the painting apparatus comprises a traveling carriage on which a painting unit as a machining unit is mounted. In the case where the machine apparatus is a conveying apparatus, the conveying apparatus comprises a traveling carriage on which a conveying unit as a machining unit for conveying a workpiece while sucking it is mounted.

As described above, in the case of installing a rail on which a traveling carriage of a machine apparatus requiring horizontal accuracy and straight traveling accuracy including a cutting apparatus travels, the rail and the rack are not integrated beforehand, and the rail members and the rack members are separate. Then, after installing a rail made up of a predetermined number of rail members while securing a preset horizontal accuracy and straight advance accuracy, the threaded holes are formed on the rack member on the site. Thereafter, the rack member with the threaded hole is attached to the rail. For this reason, it takes time to install the machine apparatus on the site.

For example, when shipping the rack member to the installation site of the machine apparatus in the state where the rack member is attached to the rail member in advance at the factory stage, it is necessary to bring the end faces of the adjacent rail members into close contact when installing the rail. However, since the predetermined machining tolerances are set for the rail member and the rack member respectively, there is a problem that it is impossible to simultaneously manage the dimension of the gap of the connecting portion of the rack member when the rail member is installed based on the required precision for the rail.

For this reason, it is necessary to process the rack and to fix it to the rail on the site after the rail is installed.

That is, in order for the traveling carriage on which the desired machining unit (for example, a cutting torch) is mounted accurately travel along the rail, the precision of the traveling direction by ensuring the straightness of the installed rail, the smooth traveling accuracy by the end portions of adjacent rails being in close contact with each other, and dimensional accuracy by eliminating fluctuation of the tooth pitch at the connecting portion between the rack members are needed.

### SUMMARY OF THE INVENTION

It is an object of the present invention to provide a rail capable of facilitating installation procedures of a rail and a rack when installing a machine apparatus having a traveling carriage.

In order to accomplish the above object, a rail of a machining apparatus having a traveling carriage on which a machining unit is mounted for performing a desired work on a workpiece, according to the present invention comprising:

rack members each rack member of which has threaded holes at predetermined positions on one surface of each rack member; and

rail members each rail member of which has a running surface formed on a head portion of each rack member with which running surface a traveling roller of the traveling carriage is in contact, guide surfaces formed on both sides of the running surface with which guide surfaces guide rollers of the traveling carriage are in contact, and an attachment surface formed below the guide surfaces for attaching each rack member, elongated holes being formed on the attachment surface at positions corresponding to those of the threaded holes,

wherein the rail members are connected at a rail member connecting portion in series such that running surfaces of adjacent rail members are in contact with each other,

wherein the rack members are arranged in series on the attachment surface such that an interval between teeth of adjacent rack members at a rack member opposing portion at which the adjacent rack members are opposed to each other is the same as a predetermined tooth pitch of the rack members, and

wherein the rack members are attached to the attachment surface by bolts which are inserted through the elongated holes and which are screwed into the threaded holes.

In the rail of a machine apparatus having a traveling carriage, it is preferable that the elongated holes formed on the attachment surface of each rail member are located at positions corresponding to those of the threaded holes formed on each rack member, the positions being determined based on one end of the running surface as a reference.

In the rail of a machine apparatus having a traveling carriage, it is preferable that the rack members are attached to each rail member such that at least one of the rack members located at the rail member connecting portion traverses the rail connecting portion and straddles adjacent rail members.

In a rail of a machine apparatus having a traveling carriage according to the present invention, threaded holes are formed at predetermined positions on the rack member. Further, elongated holes are formed at positions corresponding to those of the threaded holes of the rack member on an attachment surface of the rail member.

Therefore, when installing a rail, it is possible to arrange rail members in series and to connect adjacent rail members while running surfaces of the adjacent rail member being in contact with each other, thereby to ensure horizontal accuracy and straight advance accuracy.

Then, after installing the rail, the rack members are arranged in series on the attachment surface such that an interval between teeth of the rack members at a rack member connecting portion of the rack members is the same as a predetermined tooth pitch of the rack members, and rack members are attached to the rail member by bolts being inserted through the elongated holes. At this time, in adjusting the size of the opposing portion of the adjacent rack members even, when the error due to the accumulation of work tolerance increases, the error can be absorbed by the elongated holes.

Therefore, it is unnecessary to process the rack on site in installing the rail, and it is possible to shorten the time required for the installation work of the machine apparatus having a traveling carriage.

The elongated holes formed on the attachment surface of each rail member are located at positions corresponding to those of the threaded holes formed on each rack member. These positions are determined based on one end of the running surface as a reference. Therefore, processing tolerance does not accumulate for the elongated holes.

The rack members are attached to each rail member such that at least one of the rack members located at the rail member connecting portion traverses the rail connecting portion and straddles adjacent rail members. Therefore, the rack member functions as a connecting plate of the rail members to integrate the rail members arranged in series.

### BRIEF DESCRIPTION OF THE DRAWINGS

FIG. 1 is a diagram schematically illustrating the relationship between a rail according to the embodiment of the present invention and a cutting apparatus.

FIG. 2 is a diagram for explaining the positional relationship among a rail, a traveling roller of a cutting apparatus, a guide roller of a cutting apparatus, and a pinion of a cutting apparatus in a cross-sectional direction.

FIG. 3 is a diagram for explaining the positional relationship among a rail, a traveling roller of a cutting apparatus, a guide roller of a cutting apparatus, and a pinion of a cutting apparatus in a planer direction.

FIG. 4 is a diagram showing a sectional view of a rail.

FIG. 5 is a diagram for explaining the configuration of a rail member.

FIGS. 6A and 6B are diagrams showing an enlarged explanatory view of both end portions of a rail member respectively.

FIGS. 7A and 7B are diagrams for explaining the configuration of a rack.

### DESCRIPTION OF THE EMBODIMENTS

Hereinafter, a rail according to the present invention will be described. A machine apparatus having a traveling carriage on which a machining unit for performing a desired work on a workpiece is mounted travels on the rail according to the present invention with horizontal accuracy and straight traveling accuracy. As such a machine apparatus, there are a welding apparatus for welding a workpiece, a printing apparatus for printing letters and lines on a workpiece, a heating apparatus for heating a workpiece, a peeling apparatus for peeling paint on a surface of a workpiece, a painting apparatus for painting a surface of a workpiece, and a conveying apparatus for conveying a workpiece.

However, the machine apparatus is not limited to only these apparatuses, but may be constituted so as to have a traveling carriage on which a machining unit which performs a desired work to a workpiece with the preset accuracy is mounted. In particular, the rail is installed corresponding to whether the structure of the gutter of traveling carriage of the machine apparatus is a gate type or a cantilever type. Further, the rail according to the present invention can secure high dimensional accuracy when the cutting apparatus is of a rack and pinion driving type. Moreover, with the rail according to the present invention, the installation period can be shortened.

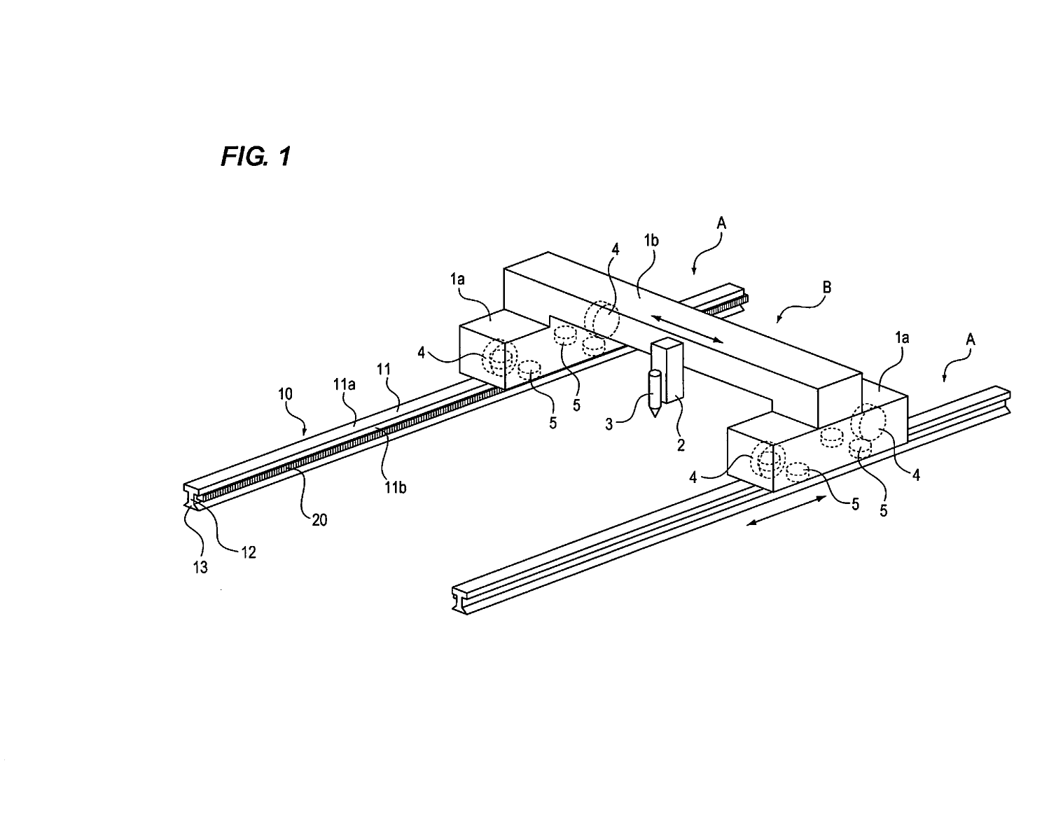

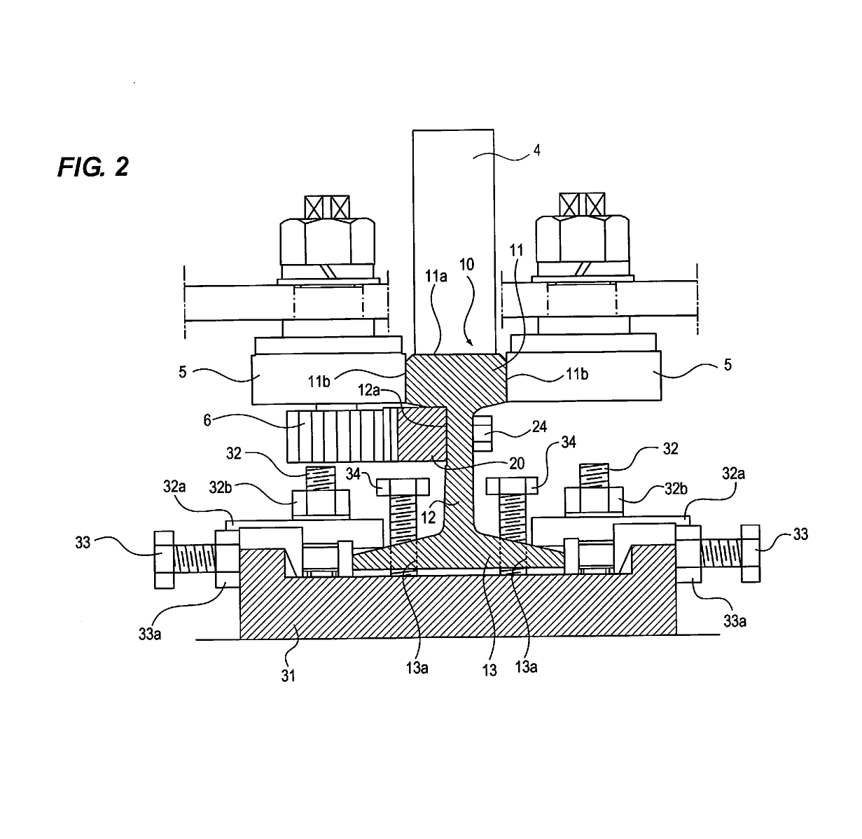

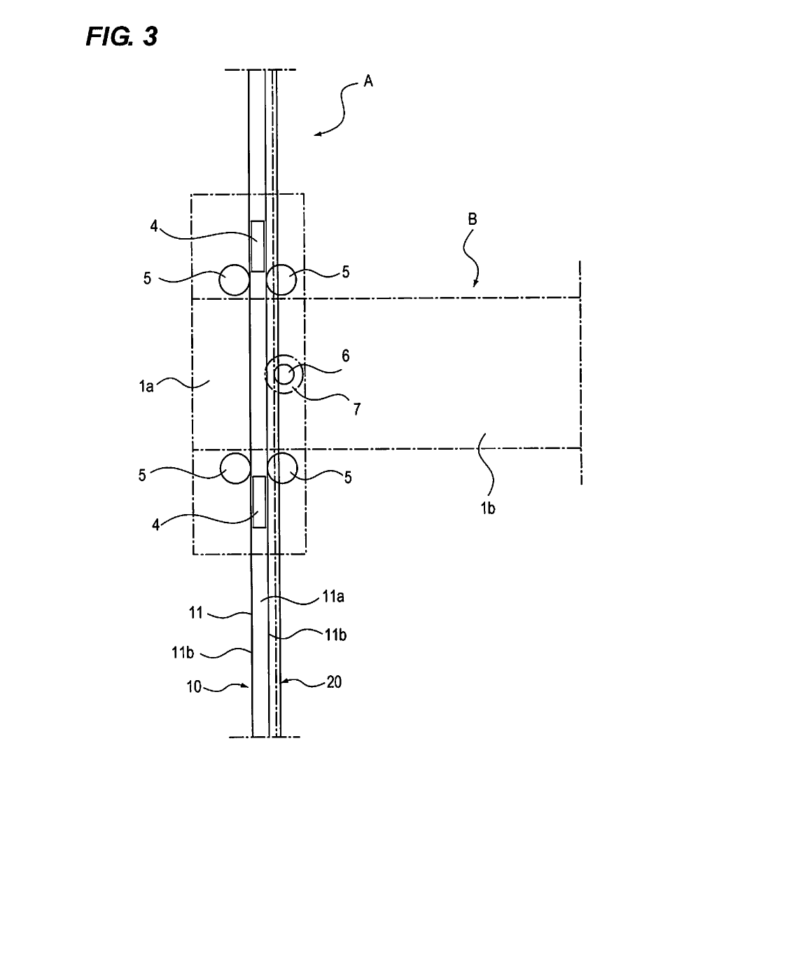

Hereinafter, the rail of the present invention will be described as a rail on which a cutting apparatus as a machine apparatus having a traveling carriage on which a cutting torch is mounted can travel horizontally while ensuring straightness. Prior to the description of the rail A, the relationship between the configuration of the cutting apparatus and the rail A will be described with reference to FIGS. 1 to 3. The cutting apparatus shown in the drawings has a traveling carriage B configured to be able to travel while being placed on a pair of rails A installed in parallel, and is configured to obtain a product having a desired shape by cutting a workpiece (not shown) disposed between the rails A.

The traveling carriage B of the cutting apparatus includes the saddles 1a respectively arranged for the rails A laid in parallel and the garter 1b which arranged in the direction orthogonal to the installation direction of the rail A. Both ends of the garter 1b are connected to the saddles 1a respectively. The traveling carriage B is of a gate shape. On the garter 1b, the traversing carriage 2 configured to be able to traverse in the direction orthogonal to the installation direction of the rails A is disposed, and the cutting torch 3 is mounted on the traversing carriage 2.

The cutting torch 3 is selected from among a gas cutting torch, a plasma cutting torch, and a laser cutting torch in accordance with conditions such as the material of a workpiece, the thickness of a workpiece, the operating time of the cutting apparatus. Therefore, facilities such as a gas supply equipment, a power supply equipment and a water supply equipment are installed around the cutting apparatus corresponding to the selected cutting torch.

In each of the saddles 1a, two traveling rollers 4 and two pairs of guide rollers 5 are arranged along the installation direction of the rails A. The traveling roller 4 is configured to be rotatable while being in contact with the running surface 11a formed on the head portion 11 of the rail member 10 which will be described later. In accordance with the rotation of the traveling rollers 4, the traveling carriage B can travel while maintaining the installation level of the rail A. The guide rollers 5 are configured to be rotatable by nipping the guide surfaces 11b formed on both sides of the running surface 11a while being in contact with the guide surfaces lib. In accordance with the rotation of the guide rollers 5, the traveling carriage B can travel in the installation direction of the rail A.

Therefore, the traveling carriage B can maintain the installation level of the rails A and precisely travel in the installation direction of the rails A by the traveling rollers 4 and guide rollers 5 rotating while being in contact with the running surfaces 11a and the guide surfaces 11b respectively. Both the traveling rollers 4 and the guide rollers 5 are configured as following rollers to which no driving force is applied.

The pinion 6 is disposed below the traveling roller 4 and the guide roller 5 arranged along the rail A. The pinion 6 meshes with the rack 20 disposed below the guide surface 11b of the rail member 10. The pinion 6 is connected to the drive motor 7 arranged in the saddled 1a. By controlling the rotation direction and the rotation speed of the drive motor 7 with a numerical control (NC) apparatus (not shown), it is possible to control the running direction and the running speed of the traveling cart B.

A traversing motor (not shown) is arranged in the traversing carriage 2. By controlling the traverse direction and traverse speed with the NC apparatus, it is possible to control the traverse direction and traverse speed of the traversing carriage 2. Therefore, by simultaneously controlling the traveling direction and the traveling speed of the traveling carriage B and the traverse direction and the traverse speed of the traversing carriage 2, it is possible to move the mounted cutting torch 3 in a desired direction at a desired speed. By operating the cutting torch 3 in accordance with the movement of the cutting torch 3, it is possible to cut off a product having a desired shape from a workpiece.

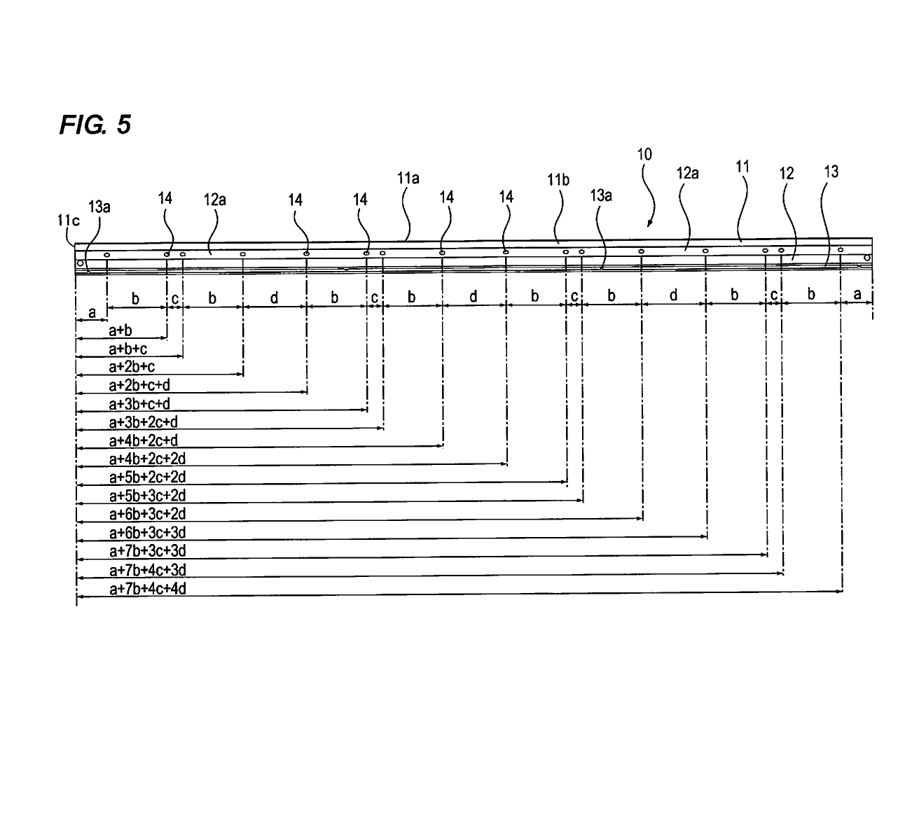

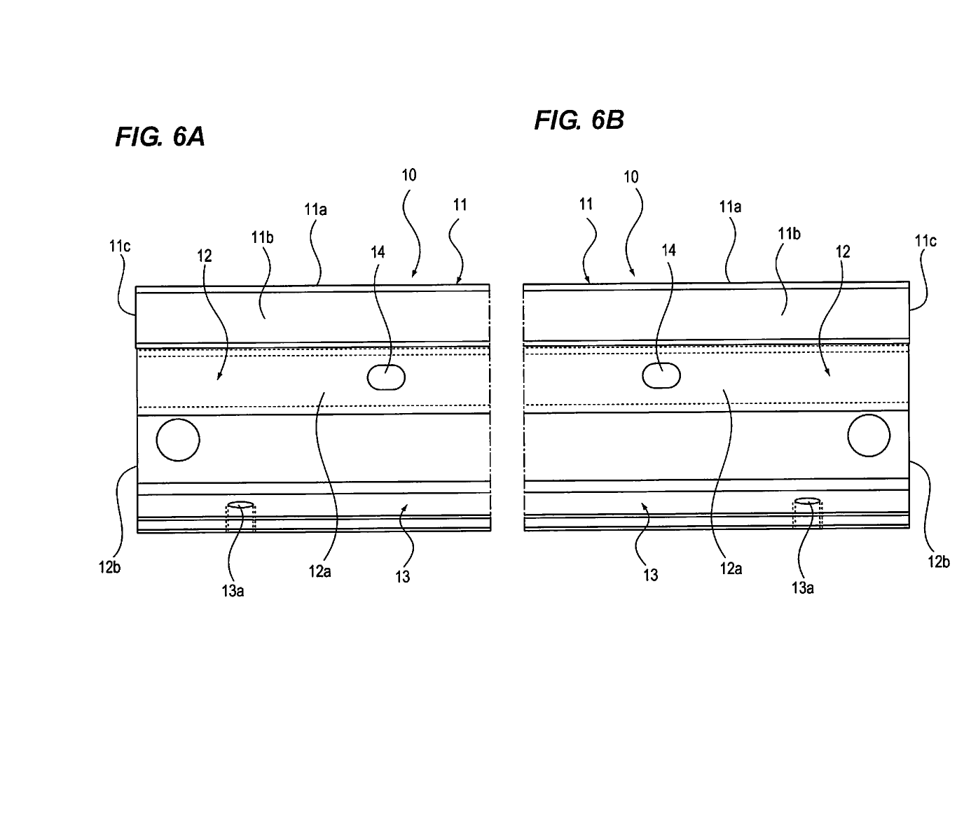

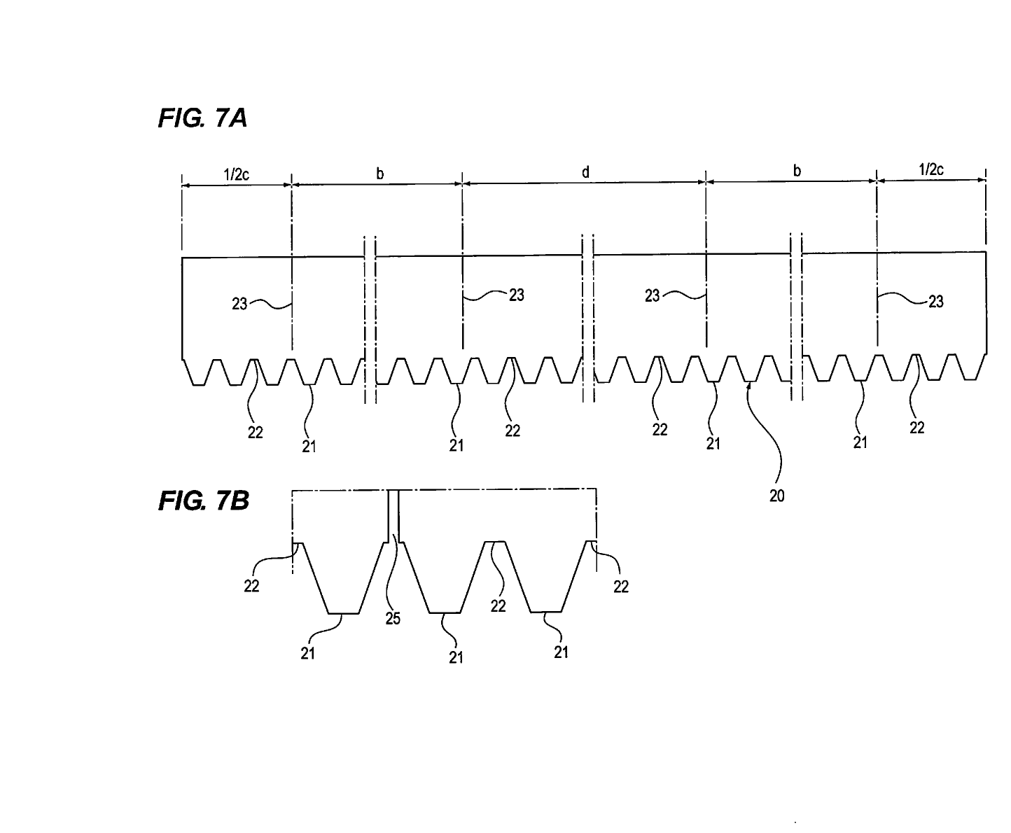

Next, the configuration of the rail A will be described. A number corresponding to preset specifications of the cutting apparatus (for example, 30, 40) of the rail members 10 each having a unit length (for example, 3 m) shown in FIGS. 5, 6A and 6B are linearly connected to form the rail A. Further, a number (for example, 120, 160) of the rack members 20 each having a unit length (for example, 0.75 m) shown in FIGS. 7A and 7B are connected to the web portion of the rail A.

The cross-sectional shape of the rail member 10 is not limited as long as the traveling carriage B of the cutting apparatus can travel straight and horizontally on the rail member 10. In the present embodiment, a rail for railway is used. The rail member 10 is obtained by precisely machining the head portion 11, the web portion 12 and the bottom portion 13 of a rail used for railway.

The running surface 11a serving as a reference surface is formed on the top surface of the head portion 11 of the rail member 10. The guide surfaces lib which are vertical surfaces are formed on both sides of the running surface 11a. The running surface 11a and the guide surface lib are formed as smooth surfaces with surface roughness Rz 6.3, respectively. Therefore, the traveling roller 4 traveling on the running surface 11a and the guide rollers 5 nipping the guide surfaces 11b can rotate smoothly and quietly.

The attachment surface 12a for attaching the rack member 20 is formed on the web portion 12 of the rail member 10 under the guide surface lib formed on the head portion 11. On the attachment surface 12a, a plurality of elongated holes 14 with preset intervals are formed. The intervals between the adjacent elongated holes 14 are set to be equal to those between the adjacent threaded holes 23 formed on the rack member 20 which will be described later. The number of the elongated holes 14 is set corresponding to the number of the threaded holes 23 formed in the rack member 20 and the number of the rack members 20 to be attached.

As shown in FIG. 5, the elongated hole 14 is positioned with respect to the connection surface 11c, which is the end surface on one side of the rail member 10. The connection surface 11c serves as a reference position (b, c, d are dimensions set for the threaded holes 23 of the rack member 20 which will be described later). Therefore, although the distance from the connecting surface 11c on one side to each elongated hole 14 has a preset allowable tolerance, the error does not accumulate even for an elongated hole at the position most distant from the connecting surface 11c.

The length of the elongated hole 14 is not particularly limited. It is preferable to appropriately set the length of the elongated hole 14 based on the diameter of the threaded hole 23 formed in the rack member 20 and the cumulative errors based on the allowable tolerances in the rail member 10 and the rack member 20. In the present embodiment, the size of the threaded hole 23 is set to M10 and the center-center distance between the long holes 14 is set to 6 mm.

The end surface of the rail member 10 in the longitudinal direction includes the connection surface 11c of the head portion 11 and the flank surface 12b. The flank surface 12b is formed on the web portion 12 and the bottom portion 13 below the connection surface d11c. The flank surface 12b has a step with respect to the connection surface 11c. The connection surface 11c is formed as a smooth surface having a surface roughness Rz 6.3 and is formed at a right angle or somewhat acute angle with respect to the running surface 11a. That is, an allowable tolerance of 90°+0°−10′ is set for the right angle between the connecting surface 11c and the running surface 11a.

When connecting the rail members 10 to each other, a force is applied in the direction in which the rail members 10 are brought close to each other to fix the connecting surfaces 11c with the connecting surfaces 11c pressed to each other. Therefore, when the connecting surfaces 11c of the two rail members 10 are opposed and connected to each other, the running surfaces 11a of the two rail members 10 are brought into contact with each other without a gap, but the web portion 12 and the bottom portion 13 are not in contact with each other and a gap is formed between them.

Therefore, when the rail members 10 are connected in series, the running surfaces 11a integrally and continuously forms a flat surface. When the travelling roller 4 of the traveling carriage B of the cutting apparatus goes over the connecting portion of the rail members 10, no rattling occurs.

As described above, the rail members 10 are fixed with the connecting surfaces 11c being pressed against each other. Therefore, the error in the allowable tolerance range occurring in each rail member 10 accumulates more as the number of connections increases.

The threaded holes 13a are formed on the bottom portion 13 of the rail member 10 for the level adjusting bolts 34 to be screwed for adjusting the horizontal of the running surface 11a when the rail A is installed.

The rack member 20 has teeth 21 having a pitch between the teeth 21 and a number of teeth 21 is set in advance. The length of the rack member 20 corresponds to the pitch between the teeth 21 and the number of the teeth 21. In the present embodiment, the rack member 20 has the pitch 10 and 75 teeth. Further, the tooth bottom having half the size of the tooth bottom 22 (about 0.5 mm) is disposed at both ends in the longitudinal direction. For this reason, the length of the rack member 20 is about 749 mm.

Therefore, as shown in FIG. 7B, when connecting the rack members 20 to each other, the gap 25 of about 1 mm is formed at the connecting portion. Namely, the end portions of the rack members 20 are opposed to each other with the gap 25 of about 1 mm. The dimensional error based on the allowable tolerance due to processing can be absorbed.

The threaded holes 23 are formed with preset intervals on the surface of the rack member 20 opposite to the surface on which the teeth 21 are formed. The number and the intervals of the threaded holes 23 are not limited. It is preferable to suitably set the number and the intervals of the threaded holes 23 in accordance with the conditions such as the length of the rack member 20. In the present embodiment, four threaded holes 23 of M10 are formed at the intervals of b (mm), d (mm) and b (mm). The threaded holes 23 located at both ends of the four threaded holes 23 are positioned at ½c (mm) from the ends of the rack member 20. These dimensions are measured based on the center of the rack member 20 as a reference.

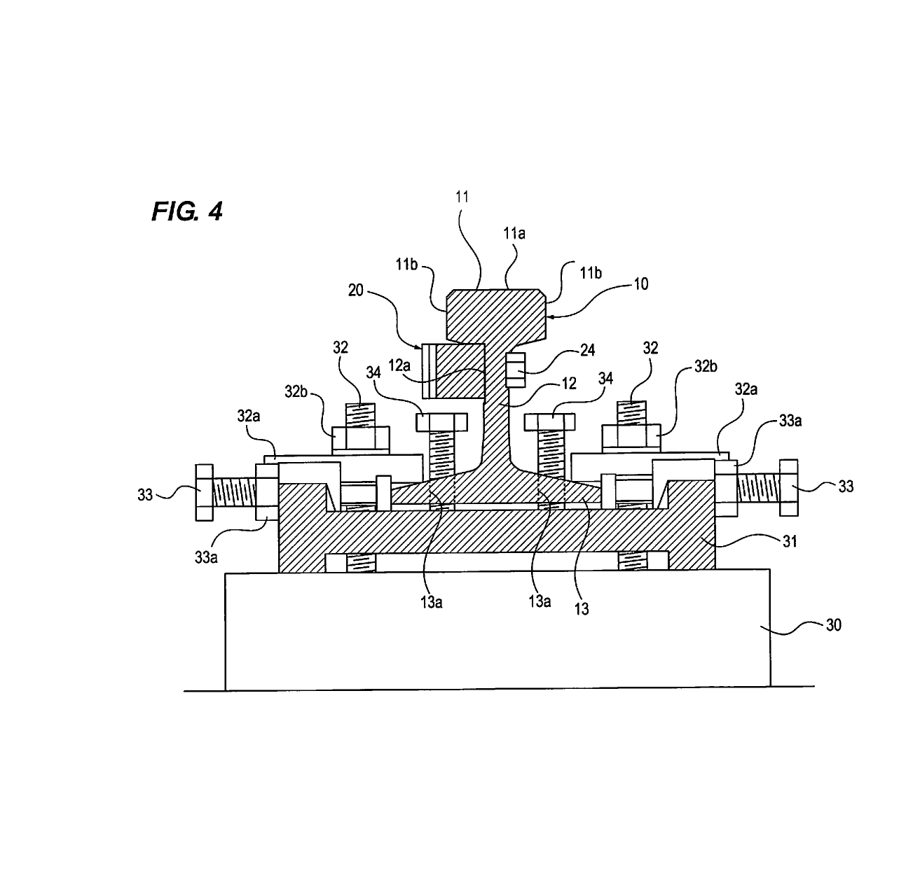

Next, the procedures for installing the rail A will be described. As shown in FIG. 4, the adjustment block 31 is previously arranged on the foundation portion 30. A plurality of adjustment blocks 31 are used for a single rail member 10. The positions of the adjustment blocks 31 in the longitudinal direction of the rail corresponds to those of the threaded holes 13a formed on the bottom portion 13 of the rail member 10. The anchor bolt 32 and the adjustment bolt 33 for adjusting the position of the rail member 10 in a horizontal plane are provided on the adjustment block 31.

The level adjusting bolt 34 is screwed into the threaded hole 13a formed on the bottom portion 13 of the rail member 10 in advance. Then, the rail member 10 with level adjusting bolt 34 being screwed is arranged on the adjustment block 31. The adjustment bolt 33 and the level adjustment bolt 34 are operated with reference to the laser beam irradiated along the installation position of the rail A in advance to adjust the position of the rail member 10 in the horizontal plane and the position f the rail member 10 in the vertical plane.

After adjusting the positions of the individual rail members 10, a force in the direction in which the adjacent rail members 10 are brought close to each other is applied to bring the running surfaces 11a into pressure contact. While keeping this state, the lock nut 33a for the adjusting bolt 33 is fastened to fix the position of the rail member 10 in the horizontal plane. Further, the anchor bolt 32 is inserted into the fixing plate 32a. With one end of the fixing plate 32a being engaged with the bottom portion 13 of the rail member 10, the nut 32b is fastened to fix the position of the rail member 10 in the vertical plane.

By installing the rail members 10 as described above, it is possible to secure the horizontal level of the running surface 11a and the straightness of the guide surfaces 11b. However, errors based on the allowable tolerances set for the individual rail members 10 accumulate, and there is a possibility that larger dimensional difference may be made on the vicinity of end portion opposite to end portion of the reference side.

When the rail members 10 are installed, the attachment surfaces 12a provided on the web portion 12 of the rail member 10 is formed as a continuous concave portion. Then, the rack member 20 is attached with one end portion of the installed rail members 10 as a reference. When connecting the rack members 20 to each other (when opposing the end portions of the rack members 20 to each other), the pitch of the teeth 21 is precisely defined using a jig (not shown).

When attaching the rack members 20 to the continuous rail members 10 from the reference side as described above, the error based on the allowable tolerance set in the rack member 20 can be absorbed by adjusting the gap 25 provided at the connecting portion (opposing portion) of the rack member 20. However, it is impossible to absorb the accumulated error as the rail members 10 are connected.

At this time, since the elongated hole 14 is formed on the attachment surface 12a of the rail member 10, it is possible to absorb the error within the range of the elongated hole 14. That is, when attaching the rack members 20 to the rail members 10, the threaded holes 23 formed in the rack members 20 are positioned within the ranges of the elongated holes 14.

Therefore, by inserting the bolts 24 into the elongated holes 14 and tightening the rack member 20, the rail A including the rail members 10 and the rack members 20 is produced.

It is preferable that at the connecting portion of the rail members 10 on which the running surfaces 11a are connected in series with each other, the rack member 20 transverses the connecting portion and is arranged to straddle the adjacent two rail members 10, and this rack member 20 is fixed to the adjacent two rail members 10. Thus, this rack member 20 functions as a connection plate of the rail members 10, and a rail in which the rail members arranged in series are integrated can be configured.

A rail of the machine apparatus according to the present invention can be applicable for a machine apparatus with a traveling carriage on which a machining unit for performing a desired work is mounted is required to travel with high dimensional accuracy.

What is claimed is:

1. A rail of a machining apparatus having a traveling carriage on which a machining unit is mounted for performing a desired work on a workpiece, comprising:
rack members each rack member of which has threaded holes at predetermined positions on one surface of each rack member; and
rail members each rail member of which has a running surface formed on a head portion of each rack member with which running surface a traveling roller of the traveling carriage is in contact, guide surfaces formed on both sides of the running surface with which guide surfaces guide rollers of the traveling carriage are in contact, and an attachment surface formed below the guide surfaces for attaching each rack member, elongated holes being formed on the attachment surface at positions corresponding to those of the threaded holes,
wherein the rail members are connected at a rail member connecting portion in series such that running surfaces of adjacent rail members are in contact with each other,
wherein the rack members are arranged in series on the attachment surface such that an interval between teeth of adjacent rack members at a rack member opposing portion at which end portions of the adjacent rack members are opposed to each other is the same as a predetermined tooth pitch of the rack members, and
wherein the rack members are attached to the attachment surface by bolts which are inserted through the elongated holes and which are screwed into the threaded holes.

2. The rail according to the claim 1,
wherein the elongated holes formed on the attachment surface of each rail member are located at positions corresponding to those of the threaded holes formed on each rack member, the positions being determined based on one end of the running surface as a reference.

3. The rail according to the claim 1,
wherein the rack members are attached to each rail member such that at least one of the rack members located at the rail member connecting portion traverses the rail connecting portion and straddles adjacent rail members.

4. The rail according to the claim 2,
wherein the rack members are attached to each rail member such that at least one of the rack members located at the rail member connecting portion traverses the rail connecting portion and straddles adjacent rail members.
